(19) United States
(12) Patent Application Publication
(10) Pub. No.: US 2004/0267978 A1
(43) Pub. Date: Dec. 30, 2004

(54) USB apparatus with embedded driver and method for installing driver

(76) Inventor: Andy C. Wu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/829,913

(22) Filed: Apr. 21, 2004

(30) Foreign Application Priority Data
Jun. 3, 2003 (TW) 92115114

(51) Int. Cl. G06F 3/00

(52) U.S. Cl. 710/10

(57) ABSTRACT

A USB apparatus (6) having an embedded driver can be operated in any one of the following three modes: a memory operating mode, a wireless communication operating mode, and an interruption mode. The USB apparatus includes a USB interface module (66) for connecting to a USB interface of a host, a wireless communication module (64) for accessing a wireless local area network, a memory module (60) for storing a driver of the wireless communication module, and for reading and writing data, and a switching module (62) for switching the wireless communication module and the memory module. The switching module includes a first analogical switch (622), a second analogical switch (624), and a mechanical switch (620) for controlling switching between the first analogic switch and the second analogic switch. A method for installing a driver of such a USB apparatus is also disclosed.

### BACKGROUND OF THE INVENTION

1. Field of the Invention

The present invention relates to a universal serial bus (USB) apparatus and a method for installing a driver thereof, and particularly to a USB apparatus having an embedded driver and a method for installing the driver to drive the USB apparatus.

2. Background of the Invention

There are only a few USB devices available, such as a flash disk or a mouse, that can use drivers embedded in a WIN 2000, WIN XP or similar operating system, and that do not need a special memory apparatus for storing the drivers. Most USB devices need specially developed additional drivers, and further need an additional memory apparatus such as a compact disc or a diskette for storing the drivers. Typical such USB devices include wireless network cards and MP3 (Moving Picture Experts Group, audio layer 3) apparatuses. The need for additional drivers and an additional memory apparatus makes use of the USB devices inconvenient.

In order to overcome this problem, Taiwan. Pat. No. 518,466, issued on Jan. 21, 2003, discloses a USB apparatus having an embedded driver and a method for installing the driver. FIG. 3 is a schematic diagram of an application environment of a USB apparatus 22 having the embedded driver. The USB apparatus 22 connects with a computer 21 via a communication port 23 of the USB apparatus 22. The driver of the USB apparatus 22 is originally stored in a read only memory (ROM) of a driver module 224. The computer 21 can obtain the driver of the USB apparatus 22 by use of a microprocessor 221 and a decoder 223 of the USB apparatus 22, and install the driver of the USB apparatus 22 therein in order to drive the USB apparatus 22.

However, even though the USB apparatus 22 does not need an additional memory apparatus for storing its driver, its driver is stored in the read only memory (ROM) of the driver module 224. Therefore, a user cannot upgrade the driver. In addition, the USB apparatus 22 has only one functional module 222. If the user needs several functions, he/she has to employ several USB apparatuses 22 each having a different function. In these circumstances, the computer 21 may not provide enough USB ports, and the user has to resort to employing a USB hub. The need for this extra equipment is inconvenient and raises costs.

### SUMMARY OF THE INVENTION

Accordingly, a primary object of the present invention is to provide a portable USB apparatus having an embedded driver.

Another object of the present invention is to provide a method for installing a driver to drive a portable USB apparatus.

In order to accomplish the above-mentioned primary object, the present invention provides a portable USB apparatus that can be operated in any one of the following three modes: a memory operating mode, a wireless communication operating mode, and an interruption mode. The portable USB apparatus comprises a USB interface module for connecting to a USB interface of a host, a wireless communication module for accessing a wireless local area network (WLAN), a memory module for storing a driver of the wireless communication module, and a switch module for switching the memory module and the wireless communication module. The memory module is further provided for reading and writing data. The switch module comprises a mechanical switch, a first analogic switch, and a second analogic switch. The mechanical switch for controlling switching between the first analogic switch and the second analogic switch comprises a memory port, a wireless communication port, and an interruption port.

When the mechanical switch is switched to the memory port, this sets up communication between the first analogic switch and the memory module, and the USB apparatus operates in memory operating mode. Simultaneously, the driver of the wireless communication module can be installed. When the mechanical switch is switched to the wireless communication port, this sets up communication between the second analogic switch and the wireless communication module, and the USB apparatus operates in wireless communication operating mode. When the mechanical switch is switched to the interruption port, this interrupts a current memory operating mode or wireless communication operating mode, and the USB apparatus operates in interruption mode.

In order to accomplish the other above-mentioned object, the present invention provides a method for installing a driver of a portable USB apparatus. The method comprises the following steps: (a) switching a mechanical switch to a memory port; (b) enabling a first analogic switch to communicate with a memory module; (c) transmitting a driver of a wireless communication module stored in the memory module to a host; (d) installing the driver of the wireless communication module; (e) switching the mechanical switch to a wireless communication port; and (f) enabling the second analogic switch to communicate with the wireless communication module, then the installed driver of the wireless communication module driving the portable USB apparatus to operate normally.

Other objects, advantages and novel features of the present invention will be drawn from the following detailed description of preferred embodiment and preferred method of the present invention with the attached drawings, in which:

### BRIEF DESCRIPTION OF THE DRAWINGS

FIG. 1 is a schematic diagram of infrastructure of a USB apparatus according to the present invention;

FIG. 2 is a flow chart of a preferred method for installing a driver of a USB apparatus according to the present invention; and

FIG. 3 is a schematic diagram of an application environment of a conventional USB apparatus having an embedded driver.

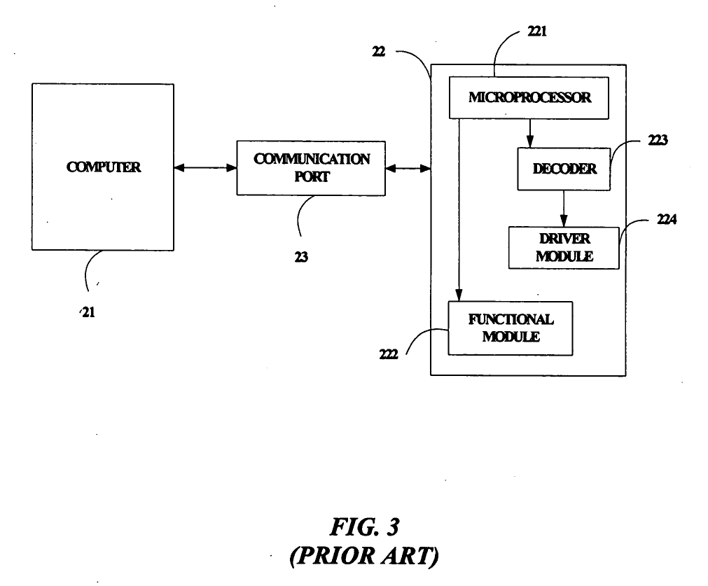

### DETAILED DESCRIPTION OF PREFERRED EMBODIMENTS

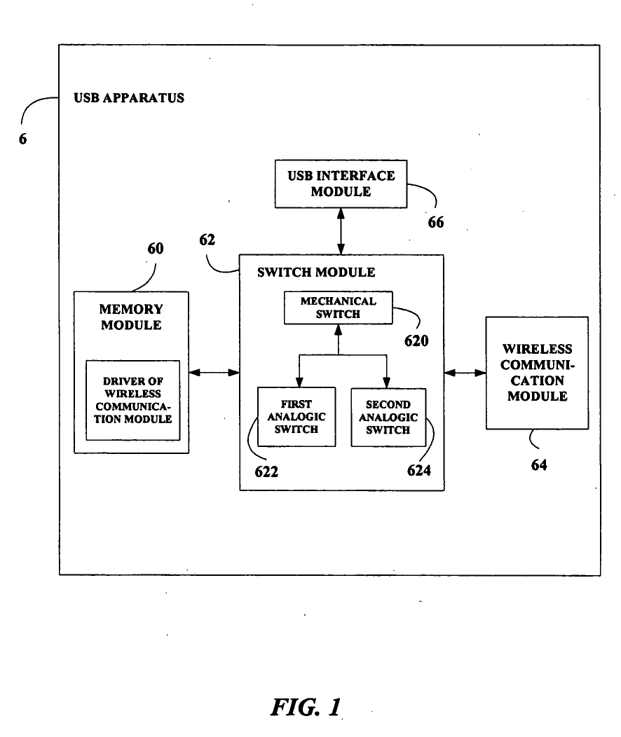

FIG. 1 is a schematic diagram of infrastructure of a USB apparatus 6 according to the present invention. The USB apparatus 6 can be operated in any one of the following three modes: a memory operating mode, a wireless communication operating mode, and an interruption mode. A default operating mode of the USB apparatus 6 is memory operating mode. The operating mode of the USB apparatus 6 can be switched among the above-mentioned three modes by use of a switch module 62 of the USB apparatus 6. When in memory operating mode, the USB apparatus 6 functions as a USB memory. When in wireless communication operating mode, the USB apparatus 6 functions as a wireless apparatus. When in interruption mode, the USB apparatus 6 maintains a connection with a host in a “sleeping” mode, waiting to be switched to memory operating mode or wireless communication operating mode.

The USB apparatus 6 of the present invention comprises a wireless communication module 64 for accessing a wireless local area network (WLAN), a memory module 60 for storing a driver of the wireless communication module 64, a switch module 62, and a USB interface module 66. All of the memory module 60, the wireless communication module 64, and the USB interface module 66 connect with the switch module 62 in duplex mode. The memory module 60, whose driver is embedded in the host's operating system (not shown), is also provided for reading and writing data. The switch module 62 comprises a mechanical switch 620, a first analogic switch 622, and a second analogic switch 624. The mechanical switch 620 comprises a memory port, a wireless communication port, and an interruption port (not shown). The mechanical switch 620 controls switching between the first analogic switch 622 and the second analogic switch 624. The USB apparatus 6 connects with the host's USB interface (not shown) through the USB interface module 66, and obtains power from USB channels.

When the mechanical switch 620 is switched to the memory port, this sets up communication between the first analogic switch 622 and the memory module 60. Then the driver of the memory module 60 embedded in the host's operating system drives the USB apparatus 6 to function as a USB memory. Simultaneously, the USB apparatus 6 operates in memory operating mode, and transmits the driver of the wireless communication module 64 to the host, which is stored in the memory module 60. When the mechanical switch 620 is switched to the wireless communication port, this sets up communication between the second analogic switch 624 and the wireless communication module 64. Then the driver of the wireless communication module 64 installed in the host drives the USB apparatus 6 to function as a wireless apparatus, and the USB apparatus 6 operates in wireless communication operating mode. When the mechanical switch 620 is switched to the interruption port, this interrupts memory operating mode or wireless communication operating mode, and the USB apparatus 6 operates in interruption mode.

In the preferred embodiment of the present invention, the memory module 60 can be a flash memory, an electrically erasable programmable read only memory (EEPROM), or any other non-volatile memory. The wireless communication module 64 can be an MP3 (Moving Picture Experts Group, audio layer 3) module, an RFID (radio frequency identifier) module, or the like.

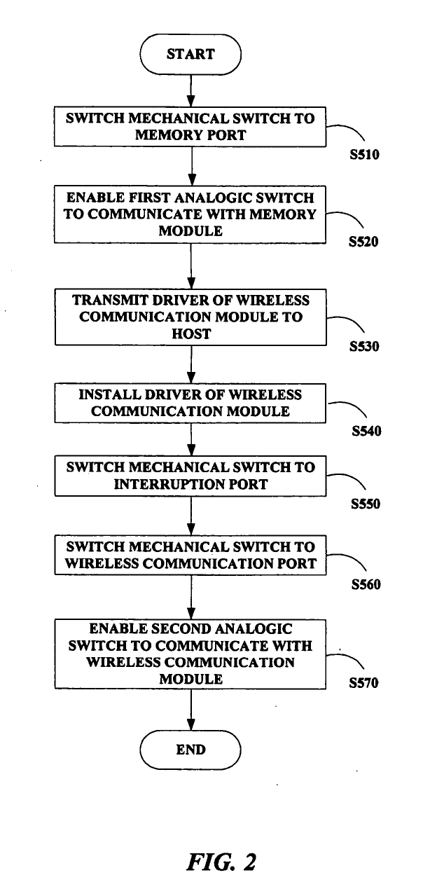

FIG. 2 is a flow chart of a preferred method for installing a driver of a USB apparatus 6, in accordance with the present invention. At step S510, a user switches the mechanical switch 620 to the memory port manually. At step S520, the mechanical switch 620 enables the first analogic switch 622 to communicate with the memory module 60. Thereupon, the USB interface module 66 sets up communication with the memory module 60, and the driver of the memory module 60 embedded in the host's operating system drives the USB apparatus 6 to function as a USB memory. At step S530, the memory module 60 transmits the driver of the wireless communication module 64 to the host. At step S540, the host installs the driver of the wireless communication module 64 therein. At step S550, the user switches the mechanical switch 620 to the interruption port for interrupting memory operating mode of the USB apparatus 6. At step S560, the user switches the mechanical switch 620 to the wireless communication port. At step S570, the mechanical switch 620 enables the second analogic switch 624 to communicate with the wireless communication module 64. Thereupon, the USB interface module 66 sets up communication with the wireless communication module 64, and the driver of the wireless communication module 64 installed in the host drives the USB apparatus 6 to function as a wireless apparatus.

While a preferred embodiment and a preferred method of the present invention have been described above, it should be understood that they have been presented by way of example only and not by way of limitation. Thus the breadth and scope of the present invention should not be limited by the above-described exemplary embodiment and method, but should be defined only in accordance with the following claims and their equivalents.

What is claimed is:

1. A universal serial bus (USB) apparatus comprising:
a USB interface module for connecting to a USB interface of a host;
a first USB module;
a second USB module, whose driver is stored in the first USB module; and
a switch module for switching the first USB module and the second USB module, the switch module comprising:
a mechanical switch;
a first analogic switch for connecting with the first USB module; and
a second analogic switch for connecting with the second USB module;
wherein the mechanical switch is for controlling switching between the first analogic switch and the second analogic switch.

2. The USB apparatus as claimed in claim 1, wherein the first USB module is a memory module for reading and writing data.

3. The USB apparatus as claimed in claim 2, wherein the second USB module is a wireless communication module for accessing a wireless local area network.

4. The USB apparatus as claimed in claim 3, wherein the USB apparatus can be operated in any one of the following three modes: a memory operating mode, a wireless communication operating mode, and an interruption mode.

5. The USB apparatus as claimed in claim 2, wherein the memory module for reading and writing data is a flash memory or an electrically erasable programmable read only memory.

6. The USB apparatus as claimed in claim 1, wherein the second USB module is an MP3 (Moving Picture Experts Group, audio layer 3) module or an RFID (radio frequency identifier) module.

7. The USB apparatus as claimed in claim 1, wherein the mechanical switch comprises a memory port, a wireless communication port, and an interruption port.

8. The USB apparatus as claimed in claim 4, wherein when the mechanical switch is switched to the memory port, this sets up communication between the first analogic switch and the memory module, and the USB apparatus operates in memory operating mode, in which the driver of the wireless communication module can be installed.

9. The USB apparatus as claimed in claim 4, wherein when the mechanical switch is switched to the wireless communication port, this sets up communication between the second analogic switch and the wireless communication module, and the USB apparatus operates in wireless communication operating mode.

10. The USB apparatus as claimed in claim 4, wherein when the mechanical switch is switched to the interruption port, this interrupts memory operating mode or wireless communication operating mode, and the USB apparatus operates in interruption mode.

11. A universal serial bus (USB) apparatus comprising:
a USB interface module for connecting to a USB interface of a host;
a USB module;
a memory module for reading and writing data, and for storing a driver of said USB module; and
a switch module for switching said USB module and the memory module, the switch module comprising:
a mechanical switch;
a first analogic switch for connecting with the memory module; and
a second analogic switch for connecting with said USB module;
wherein the mechanical switch is for controlling switching between the first analogic switch and the second analogic switch.

12. The USB apparatus as claimed in claim 11, wherein said USB module is a wireless communication module for accessing a wireless local area network.

13. The USB apparatus as claimed in claim 12, wherein the USB apparatus can be operated in any one of the following three modes: a memory operating mode, a wireless communication operating mode, and an interruption mode.

14. The USB apparatus as claimed in claim 11, wherein the memory module for reading and writing data is a flash memory or an electrically erasable programmable read only memory.

15. The USB apparatus as claimed in claim 11, wherein the USB module is an MP3 (Moving Picture Experts Group, audio layer 3) module or an RFID (radio frequency identifier) module.

16. The USB apparatus as claimed in claim 11, wherein the mechanical switch comprises a memory port, a wireless communication port, and an interruption port.

17. The USB apparatus as claimed in claim 13, wherein when the mechanical switch is switched to the memory port, this sets up communication between the first analogic switch and the memory module, and the USB apparatus operates in memory operating mode, in which the driver of the wireless communication module can be installed.

18. The USB apparatus as claimed in claim 13, wherein when the mechanical switch is switched to the wireless communication port, this sets up communication between the second analogic switch and the wireless communication module, and the USB apparatus operates in wireless communication operating mode.

19. The USB apparatus as claimed in claim 13, wherein when the mechanical switch is switched to the interruption port, this interrupts the memory operating mode or wireless communication operating mode, and the USB apparatus operates in interruption mode.

20. A method for installing a driver of a universal serial bus (USB) apparatus, the method comprising the following steps:
(a) switching a mechanical switch to a memory port;
(b) enabling a first analogic switch to communicate with a memory module;
(c) transmitting a driver of a USB module to a host;
(d) installing the driver of the USB module;
(e) switching the mechanical switch to a port corresponding to the USB module; and
(f) enabling the second analogic switch to communicate with the USB module, such that the driver of the USB module installed in the host can drive the USB apparatus.

21. The method as claimed in claim 20, wherein step (e) further comprises switching the mechanical switch to an interruption port for interrupting a memory operating mode of the USB apparatus.

22. The method as claimed in claim 21, wherein the USB module is a wireless communication module for accessing a wireless local area network.
